(19) United States
(12) Patent Application Publication
(10) Pub. No.: US 2026/0301341 A1
(43) Pub. Date: Oct. 1, 2026

(54) USER-ASSISTED SELECTION OF FORWARDED DATA IN HOLOGRAPHIC COMMUNICATIONS

(71) Applicant: QUALCOMM Incorporated, San Diego, CA (US)

(72) Inventors: Belal Salama Amin KORANY, San Diego, CA (US); Mickael MONDET, Louannec (FR); Saadallah KASSIR, San Diego, CA (US); Yann LEBRUN, Velizy-Villacoublay (FR); Peerapol TINNAKORNSRISUPHAP, San Diego, CA (US); Ravi AGARWAL, San Diego, CA (US); Hussein METWALY SAAD, Poway, CA (US); Prashanth Haridas HANDE, San Diego, CA (US)

(21) Appl. No.: 19/089,657

(22) Filed: Mar. 25, 2025

(51) Int. Cl. G06T 19/20; G06F 3/01

(52) U.S. Cl. CPC G06T 19/20; G06F 3/013; G06T 2219/2004; G06T 2219/2016

(57) ABSTRACT

This disclosure provides methods, components, devices and systems for user-assisted selection of forwarded data in holographic communications. For example, a wireless device associated with a first user may transmit information that may allow an application server to transmit relevant video frames to the wireless device. The wireless device may transmit the information via a first message as part of holographic communications between a set of users. The information may include one or more first relevance values associated with one or more other users of the set of users. The application server may obtain the one or more first relevance values and may obtain video frames associated with each of the set of users. The application server may output one or more first video frames, of the obtained video frames, associated with the first field of view of the first user in accordance with the one or more first relevance values.

### TECHNICAL FIELD

This disclosure relates generally to wireless communication, and more specifically to systems, devices, methods, and techniques associated with user-assisted selection of forwarded data in holographic communications.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a wireless communication device is described. The method may include transmitting, as part of holographic communications between a set of users including a first user and one or more other users, a first message that indicates one or more first relevance values associated with the one or more other users, where the one or more first relevance values are based on a first field of view of the first user within a virtual setting associated with the holographic communications between the set of users and receiving one or more first video frames associated with the first field of view of the first user in accordance with the one or more first relevance values.

A wireless communication device for wireless communications is described. The wireless communication device may include a processing system that includes processor circuitry and memory circuitry that stores code. The processing system may be configured to cause the wireless communication device to transmit, as part of holographic communications between a set of users including a first user and one or more other users, a first message that indicates one or more first relevance values associated with the one or more other users, where the one or more first relevance values are based on a first field of view of the first user within a virtual setting associated with the holographic communications between the set of users and receive one or more first video frames associated with the first field of view of the first user in accordance with the one or more first relevance values.

Another wireless communication device for wireless communications is described. The wireless communication device may include means for transmitting, as part of holographic communications between a set of users including a first user and one or more other users, a first message that indicates one or more first relevance values associated with the one or more other users, where the one or more first relevance values are based on a first field of view of the first user within a virtual setting associated with the holographic communications between the set of users and means for receiving one or more first video frames associated with the first field of view of the first user in accordance with the one or more first relevance values.

A non-transitory computer-readable medium storing code for wireless communications is described. The code may include instructions executable by one or more processors to transmit, as part of holographic communications between a set of users including a first user and one or more other users, a first message that indicates one or more first relevance values associated with the one or more other users, where the one or more first relevance values are based on a first field of view of the first user within a virtual setting associated with the holographic communications between the set of users and receive one or more first video frames associated with the first field of view of the first user in accordance with the one or more first relevance values.

Some examples of the method, wireless communication devices, and non-transitory computer-readable medium described herein may further include operations, features, means, or instructions for transmitting, as part of the holographic communications between the set of users, a second message that indicates one or more second relevance values associated with the one or more other users, where the one or more second relevance values may be based on a second field of view of the first user within the virtual setting associated with the holographic communications between the set of users and receiving one or more second video frames associated with the second field of view of the first user in accordance with the one or more second relevance values.

Some examples of the method, wireless communication devices, and non-transitory computer-readable medium described herein may further include operations, features, means, or instructions for transmitting an indication of an audio input by the first user as part of the holographic communications between the set of users.

Some examples of the method, wireless communication devices, and non-transitory computer-readable medium described herein may further include operations, features, means, or instructions for transmitting a request message that indicates a request to view one or more visual characteristics of at least one user of the one or more other users, where the one or more first video frames may be further based on the request.

A method for wireless communications by an application server is described. The method may include obtaining, as part of holographic communications between a set of users including a first user and one or more second users, one or more first relevance values associated with the one or more second users, where the one or more first relevance values are based on a first field of view of the first user within a virtual setting associated with the holographic communications between the set of users, obtaining a first set of video frames associated with the holographic communications between the set of users, and outputting one or more first video frames, of the first set of video frames, associated with the first field of view of the first user in accordance with the one or more first relevance values.

An application server for wireless communications is described. The application server may include a processing system that includes processor circuitry and memory circuitry that stores code. The processing system may be configured to cause the application server to obtain, as part of holographic communications between a set of users including a first user and one or more second users, one or more first relevance values associated with the one or more second users, where the one or more first relevance values are based on a first field of view of the first user within a virtual setting associated with the holographic communications between the set of users, obtain a first set of video frames associated with the holographic communications between the set of users, and output one or more first video frames, of the first set of video frames, associated with the first field of view of the first user in accordance with the one or more first relevance values.

Another application server for wireless communications is described. The application server may include means for obtaining, as part of holographic communications between a set of users including a first user and one or more second users, one or more first relevance values associated with the one or more second users, where the one or more first relevance values are based on a first field of view of the first user within a virtual setting associated with the holographic communications between the set of users, means for obtaining a first set of video frames associated with the holographic communications between the set of users, and means for outputting one or more first video frames, of the first set of video frames, associated with the first field of view of the first user in accordance with the one or more first relevance values.

A non-transitory computer-readable medium storing code for wireless communications is described. The code may include instructions executable by one or more processors to obtain, as part of holographic communications between a set of users including a first user and one or more second users, one or more first relevance values associated with the one or more second users, where the one or more first relevance values are based on a first field of view of the first user within a virtual setting associated with the holographic communications between the set of users, obtain a first set of video frames associated with the holographic communications between the set of users, and output one or more first video frames, of the first set of video frames, associated with the first field of view of the first user in accordance with the one or more first relevance values.

Some examples of the method, application servers, and non-transitory computer-readable medium described herein may further include operations, features, means, or instructions for obtaining, as part of the holographic communications between the set of users, one or more second relevance values associated with one or more third users of the set of users, where the one or more second relevance values may be based on a second field of view of a second user of the set of users within the virtual setting associated with the holographic communications between the set of users, obtaining a second set of video frames associated with the holographic communications between the set of users, and outputting one or more second video frames, of the second set of video frames, associated with the second field of view of the second user in accordance with the one or more second relevance values.

Some examples of the method, application servers, and non-transitory computer-readable medium described herein may further include operations, features, means, or instructions for obtaining an indication of an audio input by at least one user of the one or more second users, where the one or more first video frames may be based on the indication of the audio input.

In some examples of the method, application servers, and non-transitory computer-readable medium described herein, outputting the one or more first video frames may include operations, features, means, or instructions for outputting a first subset of video frames associated with a second user, of the one or more second users, in accordance with a first data rate based on a first relevance value associated with the second user satisfying a threshold relevance value and outputting a second subset of video frames associated with a third user, of the one or more second users, in accordance with a second data rate, lower than the first data rate, based on a second relevance value associated with the third user failing to satisfy the threshold relevance value.

Some examples of the method, application servers, and non-transitory computer-readable medium described herein may further include operations, features, means, or instructions for outputting a message that indicates that the first user may be to reduce an uplink video data rate based on one or more relevance values associated with the first user failing to satisfy a threshold relevance value.

### BRIEF DESCRIPTION OF THE DRAWINGS

FIG. 1 shows an example of a wireless communication system.

FIG. 2 shows an example of a signaling configuration that supports user-assisted selection of forwarded data in holographic communications.

FIG. 3 shows an example of a signaling diagram that supports user-assisted selection of forwarded data in holographic communications.

FIG. 4 shows an example of a signaling diagram that supports user-assisted selection of forwarded data in holographic communications.

FIG. 5 shows an example of a virtual environment that supports user-assisted selection of forwarded data in holographic communications.

FIG. 6 shows an example of a process flow that supports user-assisted selection of forwarded data in holographic communications.

FIG. 7 shows a block diagram of a processing system that supports user-assisted selection of forwarded data in holographic communications.

FIG. 8 shows a diagram of a system including a device that supports user-assisted selection of forwarded data in holographic communications.

FIG. 9 shows a block diagram of a processing system that supports user-assisted selection of forwarded data in holographic communications.

FIG. 10 shows a diagram of a system including a device that supports user-assisted selection of forwarded data in holographic communications.

FIGS. 11 and 12 show flowcharts illustrating methods that support user-assisted selection of forwarded data in holographic communications.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may support holographic communications between two or more users. Holographic communications may refer to technologies that support the transmission of three-dimensional (3D) images by one user to one or more other users (and their corresponding wireless communication devices), enabling the reproduction of the 3D images as a realistic representation of an individual and/or objects within a virtual setting, which may enable interactions with such individuals and objects as if they were physically present. For example, holographic communications may include video capture via a user equipment (UE) (and/or one or more peripheral devices), where corresponding video frames (e.g., including multiple packets) may be transmitted to an application server via one or more RATs (such as via a 5G or 6G system, among other examples). The video frames may be received by other UEs (and/or peripheral devices) included in the holographic communications session, which may be rendered and presented to a user. Such a rendering and presentation of one or more video frames to a user may be associated with a generation of the virtual setting associated with the holographic communications for the user.

In some cases, wireless communication systems supporting holographic communications may implement a selective forwarding unit (SFU) architecture. An SFU may be an example of a media server, an application server, or other type of server that may be configured to support, for example, group calls, videoconferencing (e.g., multi-party conferencing), and live broadcasts, among other examples. In accordance with the SFU architecture, an application server may forward (e.g., immediately forward) frames associated with the holographic communications (e.g., audio and video streams) to each of one or more other UEs. In such examples, each UE may receive the frames of all other UEs, and the frames may be used for scene rendering and display (e.g., via a headset or one or more other peripheral devices). As an example, for each time interval (e.g., for each 1/frame per second (fps)) of a holographic communications session (e.g., a call) including N users (e.g., UEs, devices), each user may transmit one video frame (e.g., a data frame) to the application server, and each user may also receive N−1 video frames from the application server.

In accordance with each user receiving video frames from all other users associated with a holographic communications session in each time interval, a downlink data rate at a wireless device (e.g., a UE and/or a peripheral device associated with a user) may increase as a quantity of users on the call increases. For example, as N increases, the quantity N−1 video frames that each user receives from the application server in each time interval may likewise increase. In other words, the downlink data rate for each user may grow linearly with the quantity of users in the call. For a call with many users, some wireless devices may be unable to support a downlink data rate that is sufficient for communicating with (e.g., receiving frames from) all other users within the call. For example, a wireless device may experience relatively poor channel conditions (including, for example, congestion) or may have an insufficient downlink resource allocation (e.g., in accordance with the wireless device sharing a network, and likewise network resources, with one or more other UEs) to support a downlink data rate that is sufficient for communicating with all other users within the call. In some systems, the application server (e.g., the SFU) may reduce the downlink data rate toward a wireless device experiencing congestion to enable the wireless device to receive frames from the other users on the call with greater reliability. However, decreasing the data rate may cause increased latency and/or visual impairments within the virtual setting rendered for a user associated with the wireless device, thus diminishing an overall user experience for the user. Thus, systems supporting holographic communications may benefit from additional techniques associated with balancing reliability and user experience.

Aspects of the subject matter described in this disclosure relate to a user-assisted selection of forwarded data in holographic communications. For example, a wireless device associated with a first user may transmit, to an application server (e.g., an SFU), information that may allow, enable, or otherwise facilitate the application server to determine a set of video frames to transmit to the wireless device (and, in some aspects, a set of video frames to refrain from transmitting to the wireless device). The set of video frames transmitted to the wireless device may include video frames depicting users within a field of view of the first user within a virtual setting (e.g., an augmented or virtual reality setting) associated with the holographic communications. In some aspects, the wireless device may transmit such information via a message as part of holographic communications between a set of users including the first user and one or more other users. The message may indicate one or more relevance values associated with the one or more other users. In some examples, the message may indicate a respective relevance value for each user of the one or more other users, with a relevance value pertaining to how relevant video of another user in the call is to the first user. For example, the wireless device may determine the one or more relevance values based on the field of view of the first user within the virtual setting associated with the holographic communications. By way of further example, a second user fully within the field of view of the first user within the virtual setting may be associated with a relatively higher relevance score and a third user outside of the field of view of the first user within the virtual setting may be associated with a relatively lower relevance score.

The application server may obtain the one or more relevance values and may selectively forward obtained video frames associated with the set of users in accordance with the one or more relevance values. For example, the application server may obtain a set of video frames and may output, to the wireless device associated with the first user, one or more video frames associated with the field of view of the first user in accordance with the one or more relevance values. The one or more video frames may indicate one or more visual characteristics of at least one other user within the virtual setting. The one or more visual characteristics may be in accordance with the one or more first relevance values (including, for example, in scenarios in which a relevance score indicates that a corresponding user is partially within the field of view of the first user). In accordance with such aspects, the wireless device may receive video frames for the first user that are relevant to the field of view of the first user. The wireless device may update one or more relevance values over time (and provide an indication of the one or more updated relevance values to the application server), such as in accordance with a (predicted, likely, determined, or measured) change in the field of view of the first user within the virtual setting, a (predicted, likely, determined, or measured) change in a speaker, and/or a (predicted, likely, determined, or measured) movement of one or more other users within the virtual setting, among other examples.

Particular aspects of the subject matter described in this disclosure can be implemented to realize one or more of the following potential advantages. In some examples, by supporting a signaling mechanism according to which the application server obtains information indicative of which other user(s) are within a (current or future) field of view of each user within the virtual setting, the application server may selectively output video frames for transmission to a user that are relevant to the user's field of view. By selectively outputting video frames that are relevant to the user's field of view, the application server may reduce an amount of downlink data by eliminating or reducing a transmission of irrelevant video frames to the user (with irrelevant video frames including, for example, video frames that convey visual characteristics outside of a field of view of the user, such that the conveyed visual characteristics are not rendered for the user). In other words, the described techniques can be used to more suitably manage (including to reduce) a total quantity of frames output from the application server (e.g., the SFU) for transmission to users associated with the holographic communications. Such techniques may likewise reduce a total quantity of frames received at a wireless device associated with the user, which may reduce processing costs at the wireless device and latency for the user. Wireless devices that apply these techniques for holographic communications may maintain a steady or suitable data rate in accordance with a (current and/or future) field of view of an associated user and may display a reliable virtual environment to a user, thus improving a user experience. In other words, in accordance with the disclosed signaling mechanisms to indicate relevance values associated with other users in a holographic communications call, various wireless devices and/or the application server may decrease overall data rates without adversely impacting the user experience.

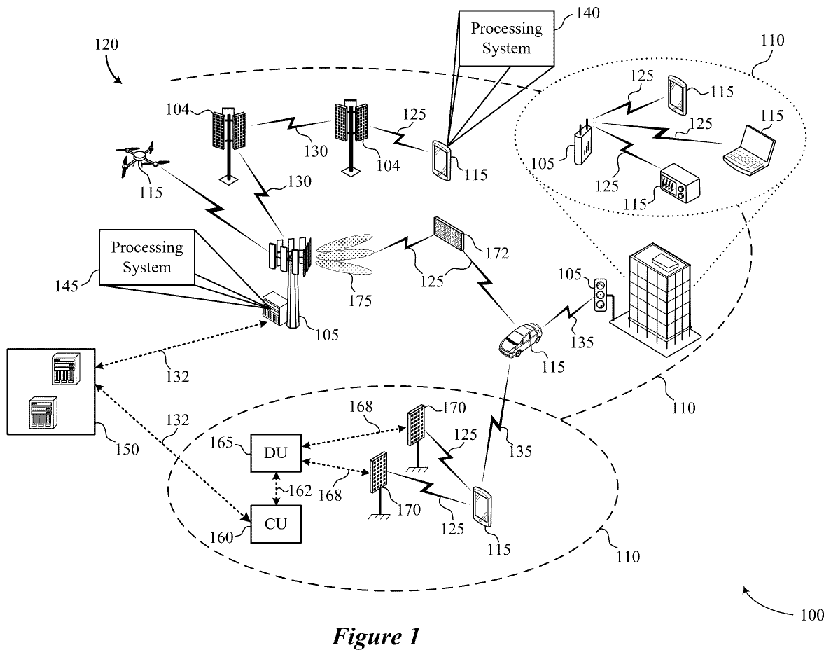

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some aspects, communication between network entities 105 may be supported using a backhaul link 132 (such as an X2, Xn, or other interface) either directly (such as directly between network entities 105) or indirectly (such as via a core network 150). In some aspects (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some aspects, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

In some SFU architectures, a holographic communications call may include a quantity of users (e.g., N users). In such a call, each user may receive N−1 frames from other users according to a frame rate (e.g., an fps). A downlink data rate for each user may thus increase according to a quantity of users on the call (e.g., linearly). For example, a data rate may be calculated according to formula (1),

D=(N−1)*s*f (1)

where D is the data rate (e.g., in bytes per second, megabytes per second, or the like), N is the quantity of users on the call, s is an average frame size (e.g., in bytes, megabytes, or the like), and f is a frame rate associated with the call (e.g., in frames per second, fps). In some cases, the data rate for a call may become relatively large (e.g., prohibitively large) for a call with many users (e.g., especially if a UE 115 associated with a user is experiencing poor channel conditions, or if the UE 115 shares a network with one or more other UEs 115). Some systems may support communication reliability by reducing a data rate for UEs 115 experiencing poor channel conditions or an insufficient downlink resource allocation. For example, such systems may support a transcoding operation at an application server (e.g., an SFU) associated with the holographic communications. Reducing the data rate (e.g., in accordance with a transcoding operation at the application server, such as the SFU), however, may adversely impact (e.g., reduce) a user experience for holographic communications calls.

Devices of the wireless communication system 100 may be configured to support one or more aspects of the described techniques for user-assisted selection of forwarded data in holographic communications. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support a wireless device (e.g., a UE 115) associated with a first user that transmits, to an application server (e.g., an SFU), information that may allow the application server to determine a set of video frames to transmit to the wireless device. The set of video frames may include video frames depicting users within a field of view of the first user within a virtual setting (e.g., an augmented or virtual reality setting associated with the holographic communications). The wireless device may transmit a first message as part of holographic communications between a set of users including a first user and one or more other users. The first message may indicate one or more first relevance values associated with the one or more other users. The wireless device may determine the one or more first relevance values based on a first field of view of the first user within a virtual setting associated with the holographic communications between the set of users.

The application server may obtain the one or more first relevance values, and may further obtain video frames associated with each of the set of users. Accordingly, the application server may output one or more first video frames, of the obtained video frames, associated with the first field of view of the first user in accordance with the one or more first relevance values. The one or more first video frames may indicate one or more visual characteristics of at least one user of the one or more other users within the virtual setting. The one or more visual characteristics may be in accordance with the one or more first relevance values. In accordance with such a selective outputting of video frames for transmission to the wireless device by the application server, the wireless device may receive video frames for the first user that are relevant for the first field of view. The wireless device may further update the relevance values to the application server (e.g., after a change in the field of view, a change in a speaker, among other examples). In some examples, by outputting video frames that are relevant according to each user's field of view, the described techniques can be used to reduce a total quantity of frames transmitted at an application server (e.g., SFU). These techniques may also reduce a total quantity of frames received at a user device, which may reduce processing and latency for the user device. User devices that apply these techniques for holographic communications may maintain a steady data rate and may display a reliable and constant virtual environment to a user, thus improving the user experience.

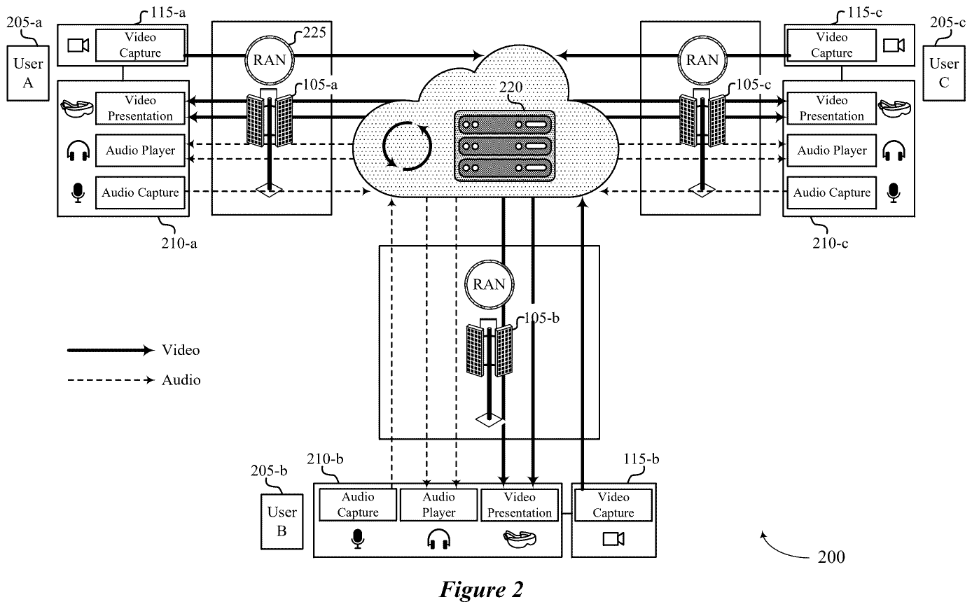

FIG. 2 shows an example of a signaling configuration 200 that supports user-assisted selection of forwarded data in holographic communications. The signaling configuration 200 may implement, or be implemented by, one or more aspects of the wireless communication system 100. In some aspects, the signaling configuration 200 may support techniques for the coordination of holographic communications between wireless communication devices.

Holographic communications may refer to technologies that enable the transmission of 3D images between users 205, allowing for the realistic representation and interaction with individuals or objects as if they were physically present. Such technology may leverage aspects of holography in which 3D images are created by recording light patterns and reconstructing the light patterns. Some holographic communications techniques may include, for example, processes for 3D image capture and reconstruction, where cameras or sensors are used to capture 3D information of a subject, including depth, texture, and color. Data associated with the 3D information may be transmitted and reconstructed using holographic displays or projectors at one or more receiving devices. Based on the rendered information, holographic communications may provide a sense of physical presence for users. As such, holographic communications may be beneficial in various applications and industries. For instance, holographic communications may be utilized for virtual meetings, teleconferences, and collaborative environments where spatial awareness and the ability to perceive gestures and expressions in 3D are valued or appreciated by users.

Holographic communications may be a use case association with 6G devices and may be part of an immersive communications category (e.g., alongside extended reality (XR) and telepresence). Features of holographic communications may include ultra-realistic real time 3D interactions and multi-sensorial experience. Moreover, holographic communications may provide enhancements to various fields, including, for example, business and telepresence (e.g., for immersive and effective remote meetings, presentations, and conferences), entertainment and media (e.g., providing enhanced forms of viewer engagement and interactive experiences), education and training (e.g., providing engaging and interactive learning experiences, such as virtual classrooms and simulations), healthcare (e.g., telemedicine and remote consultations with a more realistic representation of patients or medical data), and technology development (e.g., development of computational power, bandwidth, and display technologies), to name a few. In some examples, holographic communications may involve two or more users 205, and the data associated with the holographic communications may be represented as holograms in XR scenes (where XR may include or be associated with virtual reality (VR), augmented reality (AR), mixed reality (MR), or similar technologies). Such holographic communications may operate under relatively strict operating parameters (e.g., technical requirements). For example, holographic communication applications may use a relatively high bandwidth and advanced compression techniques, and may operate with relatively low latency.

The signaling configuration 200 illustrates a system that supports holographic communications between multiple users 205, where each user 205 may be associated with one or more wireless communication devices, such as a UE 115 or one or more devices 210 (e.g., one or more peripheral devices). As an example, a first user 205-a (e.g., user A) may be associated with a first UE 115-a or one or more devices 210-a (e.g., peripheral devices), where the UE 115-a or the devices 210-a may be an example of a UE 115 described with reference to FIG. 1. Similarly, a second user 205-b (e.g., user B) may be associated with a second UE 115-b and one or more devices 210-b (e.g., peripheral devices), and a third user 205-c (e.g., user C) may be associated with a third UE 115-c and one or more devices 210-c (e.g., peripheral devices). Some aspects of the present disclosure may be described with reference to a user transmitting and/or receiving frames or performing some operations, and it will be clear to a person having ordinary skill in the art that such descriptions refer to the devices or UEs 115 associated with a user that transmit/receive frames or perform some operations in association with one or more network entities 105 and RATs. For example, a user transmitting one or more frames is understood to mean that a UE 115 or one or more devices associated with the user transmit the one or more frames, which may be signaled via one or more network entities 105 that operate in accordance with one or more RATs.

The one or more devices 210 associated with each user 205 may include, for example, one or more headsets, booths, tables, projectors, displays, speakers, or other types of devices and components that support or are configured for rendering of audio and video associated with holographic communications. Such devices may be portable or unportable. As an illustrative example, the one or more devices 210-a may include a headset display that supports video presentation, speakers that support audio presentation, and a microphone that supports audio capture. Further, the UE 115-a may support video capture associated with the holographic communications. In some cases, the UE 115-a may be coupled with (e.g., via a wireless connection, via a wired connection, or both) the one or more device 210-a. In some cases, a UE 115-a may be capable of performing the operations associated with the holographic communications. For example, the UE 115-a may be capable of video capture, video rendering and presentation, audio playback, or audio capture. As such, the techniques, functions, and capabilities described herein with reference to a UE 115 may similarly apply to the one or more devices 210, and vice versa. In some examples, one or more UEs 115 or the one or more devices 210 may be associated with an application client for the holographic communications, where the application client may communicate sets of frames with the application server.

In some examples, data associated with the UEs 115 and the one or more devices 210 may be communicated via one or more network entities 105 (e.g., a network entity 105-a, a network entity 105-b, a network entity 105-c), which may each be an example of a network entity 105 described with reference to FIG. 1. As an example, the UE 115-a may utilize one or more application to capture video associated with the holographic communications (e.g., using one or more cameras), and the UE 115-a may transmit a set of frames (e.g., video frames, data frames) to an application server 220 via a network entity 105-a. Similarly, the one or more devices 210-a may exchange signaling with the application server 220 via the network entity 105-a. For example, a headset that supports video presentation may receive a set of frames (e.g., video frames, which may be referred to as data frames) from the application server 220 that may be rendered for the holographic communications, and an audio player may receive a set of frames (e.g., audio frames) from the application server 220 that may provide corresponding audio for the holographic communications. In any case, the network entity 105-a may be associated with a RAN 225 (such as a 5G NR network) and may operate in accordance with one or more RATs associated with the RAN 225. In some examples, a UE 115 may receive the frames from the application server 220, and the UE 115 may provide the frames to the one or more devices 210, or the UE 115 may be configured to render audio and video using the received frames.

In some aspects, the signaling configuration 200 may implement an SFU architecture. An SFU may be an example of a media server, an application server, or other type of server that may be configured to support group calls, videoconferencing (e.g., multi-party conferencing), and live broadcasts, among other examples. In the SFU architecture, every connected device may transmit a set of outgoing media streams to a server (e.g., an application server 220), and the set of streams is forwarded to every other device by the SFU. As an example, an application server 220 (e.g., associated with the SFU architecture) may forward (e.g., immediately forward) frames associated with the holographic communications to each UE 115 (e.g., UE 115-a, UE 115-b, UE 115-c) or the one or more devices 210 (e.g., devices 210-a, devices 210-b, devices 210-c). In such examples, each UE 115 may receive the frames of all other UEs 115, and the frames may be used for scene rendering and display by the UE 115 or the one or more devices 210 (e.g., via a headset or one or more other peripheral devices). Here, for each time interval (e.g., each 1/fps, where fps may be, for example, 60 fps) of a holographic communications session including N users 205, each UE 115 may transmit one frame (e.g., video frame, data frame) to the application server, and each UE 115 (or one or more devices 210) may receive N−1 frames (e.g., N−1 video frames) from the application server 220. Put differently, frames may be transmitted periodically to the application server 220, and the application server 220 may forward the frames to all other users 205 (e.g., UEs 115 or devices 210) immediately.

In some cases, a wireless device (e.g., used by or otherwise associated with a first user) may periodically receive a frame from each other user within the call (e.g., according to a frame rate). Accordingly, a downlink data rate at the wireless device may increase as a quantity of users on the call increases. For a call with many users, the wireless device may be unable to support the downlink data rate for communicating with all users within the call. In some wireless communications systems, the wireless device experience a decreased the data rate to allow for many users on the call (e.g., in accordance with the application server reducing the data rate, such as via a transcoding operation, for frames output for transmission to that wireless device). However, decreasing the data rate may cause increased latency and visual impairments within the virtual setting, thus diminishing the user experience.

As described herein, techniques may enable a wireless device (e.g., a UE 115 and/or a device 210, such as a peripheral device) associated with a first user to transmit information to an application server 220 (e.g., an SFU). The information may allow the application server 220 to determine a set of video frames to transmit to the wireless device. The set of video frames may include video frames depicting users within a field of view of the first user within a virtual setting (e.g., an augmented or virtual reality setting). The wireless device may transmit a first message as part of holographic communications between a set of users including a first user and one or more other users. The first message may indicate one or more first relevance values associated with the one or more other users. The wireless device may determine the one or more first relevance values based on a first field of view of the first user within a virtual setting associated with the holographic communications between the set of users.

The application server 220 may obtain the one or more first relevance values, and may further obtain video frames associated with each of the set of users. The application server 220 may output one or more first video frames, of the video frames, associated with the first field of view of the first user in accordance with the one or more first relevance values. The one or more first video frames may indicate one or more visual characteristics of at least one user of the one or more other users within the virtual setting. The one or more visual characteristics may be in accordance with the one or more first relevance values. The wireless device may receive video frames for the first user that are relevant for the first field of view. The wireless device may further update the relevance values to the application server 220 (e.g., after a change in the field of view, a change in a speaker, among other examples).

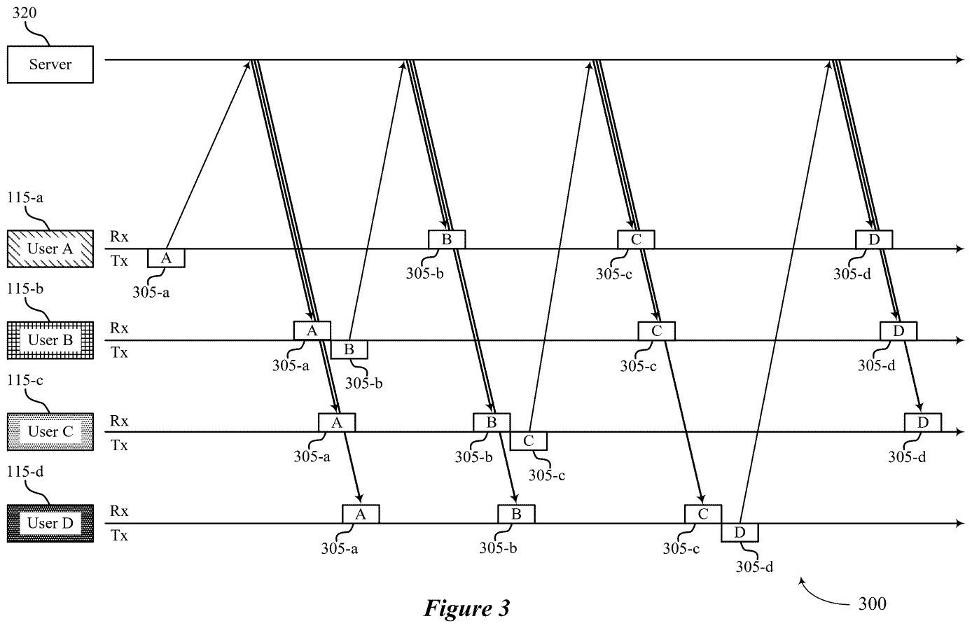

FIG. 3 shows an example of a signaling diagram 300 that supports user-assisted selection of forwarded data in holographic communications. The signaling diagram 300 may implement or be implemented by aspects of the wireless communication system 100 and the signaling configuration 200. For example, the signaling diagram 300 may illustrate the transmission and reception of one or more frames 305 by one or more wireless communication devices associated with respective users (e.g., a first UE 115-a, a second UE 115-b, a third UE 115-c, and a fourth UE 115-d).

The frames 305 communicated by each UE 115 may, additionally, or alternatively, be transmitted or received by one or more peripheral devices, which may be examples of the corresponding devices described with reference to FIGS. 1 and 2. As an example, the first UE 115-a may be coupled with (e.g., via a wired link or a wireless link, or both) or more peripheral devices that may each support techniques and functions associated with holographic communications (such as video capture, video presentation, audio capture, audio playback, among other examples). Although sometimes not shown, each UE 115 may communicate (e.g., transmit and receive) signaling with the application server 320 via one or more network entities (such as a network entity 105 described with reference to FIGS. 1 and 2). That is, each UE 115 depicted in the signaling diagram 300 may transmit and receive frames 305 via at least one network entity 105, where the at least one network entity 105 may be used for communicating the frames 305 between the application server 320 and each UE 115 of a set of multiple UEs 115 (e.g., the UE 115-a, the UE 115-b, the UE 115-c, the UE 115-d, and so forth). In some aspects, the application server 320 may be an example of the application server 220 described with reference to FIG. 2. The UE 115-a, the UE 115-b, the UE 115-c, the UE 115-d may each be examples of a UE 115 as illustrated by and described with reference to FIGS. 1 and 2.

The signaling diagram 300 may show signaling exchanged between the UEs 115 (e.g., corresponding to or otherwise associated with respective users) as part of a holographic communication session (e.g., a holographic communications call). For example, the signaling diagram 300 may represent signaling in a wireless communications system that supports holographic communications (such as the wireless communication system 100 and the signaling configuration 200 described with reference to FIGS. 1 and 2, respectively), which may implement an SFU architecture. Accordingly, after reception of a frame 305 from a UE 115 (e.g., user i), the application server 320 may send the received frame to all other UEs 115 (e.g., users j). In some aspects, the application server 320 may send the frames to the other UEs 115 immediately (e.g., without delay, with minimal delay, within a threshold duration). Further, in a holographic communications session that includes N users (e.g., N UEs 115), each user may receive N−1 frames 305 from other users every 1/fps.

For example, and as shown in the signaling diagram 300, a first UE 115-a (e.g., associated with a user A) may transmit a first frame 305-a to the application server 320, which may forward the first frame 305-a to the second UE 115-b (e.g., associated with a user B), the third UE 115-c (e.g., associated with a user C), and the fourth UE 115-d (e.g., associated with a user D). Similarly, the second UE 115-b may transmit a second frame 305-b to the application server 320, which may forward the second frame 305-b to the first UE 115-a, the third UE 115-c, and to the fourth UE 115-d. The third frame 305-c sent by the third UE 115-c and the fourth frame 305-d sent by the fourth UE 115-d may be similarly forwarded by the application server 320 to each other UE 115. Additional UEs 115 (not shown) may likewise exchange frames 305 via the application server 320, as a holographic communications session may include multiple users, and the quantity of UEs 115 (and users) shown in the examples provided herein should not be considered limiting to the scope of the claims or the disclosure.

An instant in time when a UE 115 transmits a frame 305 may determine the instant when the application server 320 receives the frame 305, and the respective instants when other UEs 115 receive the frame 305 from the application server 320. That is, the timing of a frame transmission may affect both when the application server 320 receives a frame and when other wireless communication devices associated with holographic communications receive the frame 305. In some examples, instants that users transmit their respective frames may be uncoordinated (e.g., independent of each other).

In accordance with each UE 115 (e.g., a wireless device) periodically receiving a frame from each other UE 115 (e.g., each other user) within the call, a downlink data rate at the UE 115 may increase as a quantity of users on the call increases. For a call with many users, the UE 115 may be unable to support the downlink data rate for communicating with (e.g., receiving frames from) all other UEs 115 within the call. In some wireless communications systems, the application server 320 may reduce a data rate for a UE 115 experiencing relatively poor channel conditions, an insufficient downlink resource allocation, or another condition that results in the UE 115 being unable to support the downlink data rate for communicating with the other UEs 115 within the call. However, decreasing the data rate may cause increased latency and visual impairments within the virtual setting, thus diminishing the user experience.

As described herein, one or more wireless communication devices (such as the UE 115-a, the UE 115-b, the UE 115-c, the UE 115-d, the application server 320, and/or one or more other devices) may utilize techniques to enable user-assisted selection of forwarded data in holographic communications. For example, a wireless device (e.g., the UE 115-a) associated with a first user may transmit, to the application server 320, information that may allow the application server 320 to determine a set of video frames to transmit to the wireless device. The set of video frames may include video frames depicting users within a field of view of the first user within a virtual setting (e.g., an augmented or virtual reality setting). The wireless device may transmit a first message as part of holographic communications between a set of users including a first user and one or more other users. The first message may indicate one or more first relevance values associated with the one or more other users. The wireless device may determine the one or more first relevance values based on a first field of view of the first user within a virtual setting associated with the holographic communications between the set of users.

The application server 320 may obtain the one or more first relevance values, and may further obtain video frames associated with each of the set of users. Accordingly, the application server 320 may output one or more first video frames, of the video frames, associated with the first field of view of the first user in accordance with the one or more first relevance values. The one or more first video frames may indicate one or more visual characteristics of at least one user of the one or more other users within the virtual setting. The one or more visual characteristics may be in accordance with the one or more first relevance values. Thus, the wireless device may receive video frames for the first user that are relevant for the first field of view. The wireless device may further update the relevance values to the application server 320 (e.g., after a change in the field of view, a change in a speaker, among other examples).

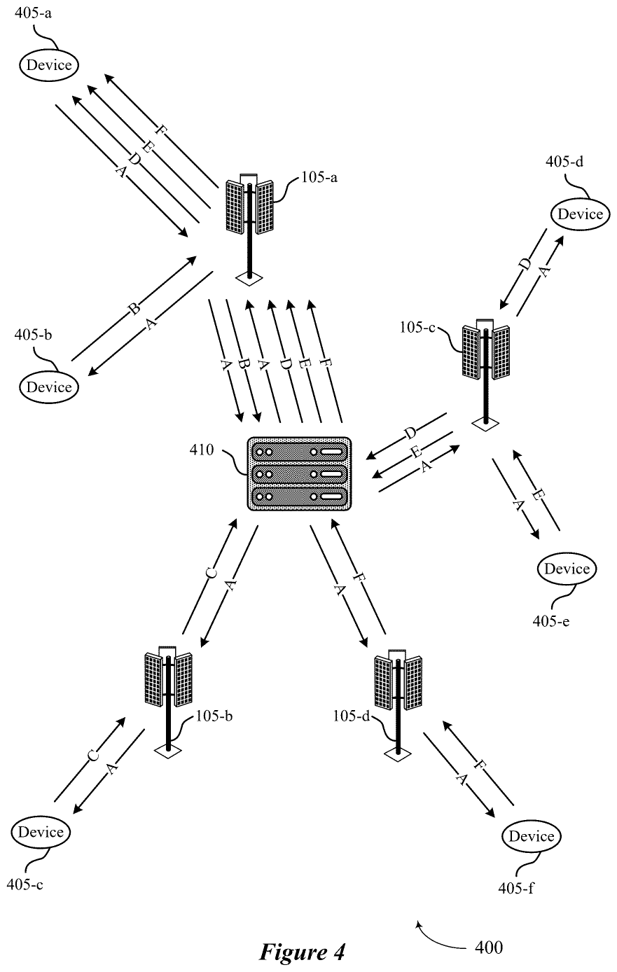

FIG. 4 shows an example of a signaling diagram 400 that supports user-assisted selection of forwarded data in holographic communications. The signaling diagram 400 may implement or be implemented by one or more aspects as described herein with reference to FIGS. 1-3. For example, the signaling diagram 400 includes one or more devices 405 (e.g., a device 405-a, a device 405-b, a device 405-c, a device 405-d, a device 405-e, a device 405-f), one or more network entities 105 (e.g., a network entity 105-a, a network entity 105-b, a network entity 105-c, a network entity 105-d), and an application server 410. The one or more devices 405 may be examples of one or more UEs 115 that support holographic communications. The signaling diagram may illustrate signaling for a holographic communications session or a holographic communications call. Each device 405 (e.g., wireless communication device) may communicate with the application server 410 either directly or indirectly through a relay node (e.g., a network entity 105) as shown in the signaling diagram 400. In the following description, each device 405 (e.g., corresponding to each user) may perform operations similar to the device 405-a. Further, operations performed by other entities (e.g., the application server 410) in conjunction with the device 405-a may be performed with each device 405.

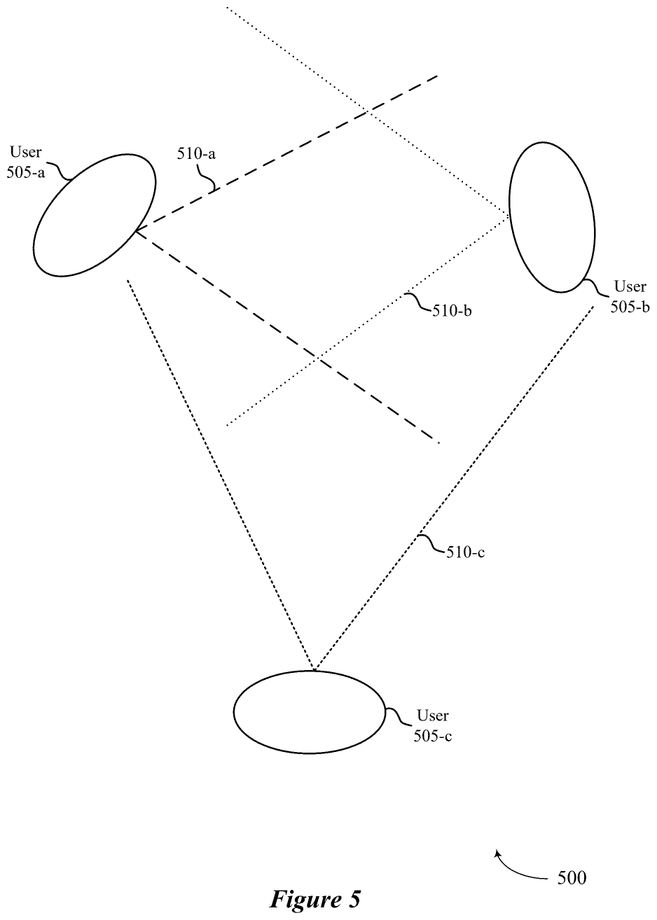

In some aspects, the device 405-a (e.g., a UE 115) may share information with the application server 410 (e.g., an SFU) to help the application server 410 to select data to transmit to the device 405-a (e.g., which data the device 405-a is to download, or which data the application server 410 is to download for transmission to the device 405-a). The device 405-a may transmit, to the application server 410, a message including a relevance value (e.g., relevance score) corresponding to each other user (e.g., each other avatar) corresponding to the other devices 405 in the call. The device 405-a may transmit the message based on a predicted viewpoint at the device 405-a and based on predicted user locations within the call (e.g., as described in further detail with reference to FIG. 5). The device 405-a may share the relevance values of the other users with the application server 410. The device 405-a may transmit the relevance values in a message that also includes data corresponding to the device 405-a (e.g., piggybacking) to the application server 410 (e.g., according to a frame rate of the call). Additionally, or alternatively, the device 405-a may transmit the relevance values to the application server 410 as or via a separate assistance information message.

In some examples, the device 405-a may determine (and transmit) relevance values based on one or more inputs such as modem input, eye tracking input, user settings, settings of the device 405-a, or any combination thereof. In some examples, a modem may transmit one or more messages to an application (e.g., running on a device) that indicate one or more factors associated with the call. For example, the modem may indicate that power consumption satisfies a threshold (e.g., power consumption is too high). In response to determining that the power consumption satisfies the threshold, the device 405-a may lower relevance scores (e.g., to reduce a data rate associated with the call). Additionally, or alternatively, (e.g., in a bad channel condition scenario or a low power state), the device 405-a may apply (e.g., use) eye tracking to reduce a relevance of other users (e.g., avatars) that are in a field of view of the device 405-a but that are out of focus. Additionally, or alternatively, the device 405-a may determine to download data of a particular user even if the user is not in the field of view of a user associated with the device 405-a (e.g., based on a user input or request, such as if the device 405-a is in a high power state). In other words, the relevance values may be based on, associated with, or otherwise in accordance with a power state (e.g., a high power sate, a lower power state) and/or a channel condition (e.g., a relatively good channel condition, a relatively poor channel condition) of the device 405-a, which may enable the device 405-a to balance performance (and user experience) with power consumption.

In some aspects, the device 405-a may transmit, to the application server 410, one or more indications associated with properties of the call from a perspective of the user of the device 405-a. For example, the one or more indications may include a binary flag indicating an audio input of the device 405-a (e.g., whether the user associated with the device 405-a is talking or not talking). In some aspects, video data of a talking user may be forwarded to other users regardless of relevance scores (e.g., because a talking user may be likely to enter a field of view of other users, such as in accordance with the other users “turning toward” the talking user within the virtual setting). In some aspects, the device 405-a may send an indication of a request to download one or more portions of a hologram of another user (e.g., a portion of an avatar of another user). In response, the application server 410 may transmit the one or more portions of the hologram to the device 405-a. In some aspects, downloading only a portion of another user's hologram (e.g., avatar) may be beneficial if the hologram of the other user is partially inside the field of view of the device 405-a (e.g., only a head, torso, or arms of the hologram, among other examples, may be in the field of view). Further, applying such techniques may be beneficial in relatively poor channel conditions, where a user can save resources by selectively downloading (only) relevant parts of holograms within the field of view. In some aspects, a device 405-a may transmit, to the application server 410 (e.g., with video data), an indication of six degrees of freedom (6DoF) associated with the device 405-a (e.g., directions in which the device 405-a may move an avatar or change its field of view within the call). In some examples, transmitting an indication of the 6DoF (and forwarding the indication to other users) may be help a rendering engine (e.g., of one or more other users) to place the user of the device 405-a in the virtual space (e.g., the virtual setting associated with or in the holographic call).

In some aspects, the application server 410 (e.g., the SFU) may perform one or more operations in response to receiving relevance scores (and video frame data) from the one or more devices 405. For example, the application server 410 may forward video data to each device 405 that is relevant (e.g., highly relevant, such as video data associated with a source that has above a threshold relevance score) to each device 405. In some aspects, the application server 410 may forward video frame data corresponding to users within the field of view of the device 405-a to the device 405-a (e.g., from the devices 405 corresponding to the users within the field of view). For example, the application server 410 may transmit, to the device 405-a, video frame data corresponding to (e.g., sourced or originated from) the device 405-d, the device 405-e, and the device 405-f (e.g., shown as arrows ‘D’, ‘E’, and ‘F’ in the signaling diagram 400) if the users corresponding to these devices are within the field of view of the device 405-a. In such examples, the application server 410 may refrain from transmitting, to the device 405-a, video frame data corresponding to (e.g., sourced or originated from) the device 405-b and the device 405-c (e.g., shown as arrows ‘B’ and ‘C’ in the signaling diagram 400). In other words, the 405-a may indicate relatively higher relevance scores (e.g., scores that satisfy a threshold relevance score) for the device 405-d, the device 405-e, and the device 405-f and relatively lower relevance scores (e.g., scores that fail to satisfy the threshold relevance score) for the device 405-b and the device 405-c. In some aspects, the application server 410 may forward audio data (e.g., positional audio data) from each device 405 to each other device 405 (e.g., the device 405-a may receive audio data from device 405-b, the device 405-c, the device 405-d, the device 405-e, and the device 405-f, regardless of the relevance scores indicated by the device 405-a).

In some aspects, the application server 410 may encode relevant data (e.g., highly relevant data, such as video data associated with a source that has above a threshold relevance score) with a relatively higher bit rate than data which is relatively less relevant for the device 405-a (e.g., data corresponding to users outside the field of view, or only partially within the field of view) according to a transcoding capability of the application server 410. Similarly, the application server 410 may encode less relevant data with a relatively lower bit rate (e.g., encoding data with a bit rate proportional to or based on a relevance value corresponding to the data). Accordingly, in some aspects, the device 405-a may receive video data (e.g., images, video frames) corresponding to each user in the call, but may receive data corresponding to users outside the field of view with a relatively low resolution (e.g., a lower quality).

In some aspects, the application server 410 may determine (e.g., decide, select, or identify) to override relevance scores provided by one or more devices 405. For example, if a first user corresponding to the device 405-a starts talking, the application server 410 may predict that other users will look at the first user (e.g., by turning their head, at least within the virtual setting associated with the holographic communications). Accordingly, the device 405-a may send a flag (e.g., a binary flag in combination with audio data from the device 405-a) to indicate whether the first user is talking. If the flag indicates that the first user is talking, the application server 410 may forward video data of the first user to the other devices 405 on the call (regardless of the relevance scores indicated by the other devices for the first user). For example, each device 405 may receive the video data of the first user of the device 405-a (e.g., each device 405 receiving arrow ‘A’ as illustrated in the signaling diagram 400).

In some aspects, the application server 410 may determine that a second user corresponding to device 405-b is not in a field of view of any another user (e.g., and, likewise, that video of the second user is irrelevant to other users). In such aspects, the application server 410 may transmit a message to the device 405-b indicating that the device 405-b is to reduce an uplink video data encoding bit rate (or may indicate that the device 405-b is to refrain from uploading video data for at least a duration). Applying such techniques may save uplink data resources and other resources at the device 405-b, thus saving power. These techniques may be beneficial in scenarios in which uplink transmission resources are limited for some devices (e.g., as these techniques may reduce a bottleneck associated with uplink communication, with uplink being a frequent bottleneck in some wireless communications systems).

In some aspects, the device 405-a may report a relatively large change in a relevance score for a second user (e.g., if the second user enters or exits the field of view of the device 405-a). In such aspects, the device 405-a, the application server 410, or both may determine that a data rate is expected to change (e.g., in response to the relatively large change in relevance score). In such aspects, an application client (e.g., running on the device 405-a) may signal an expected data rate change to a modem (e.g., through a cross-layer API). In response, the modem may signal the expected data rate change to the network entity 105-a (e.g., the RAN) so that the network entity 105-a may allocate communication resources accordingly (e.g., for the network entity 105-a, the modem, and the device 405-a, such as for over-the-air communication between the network entity 105-a and the device 405-a). In some examples, the modem may use a message field (e.g., a desired bitrate field of a recommended bit rate (RBR) query MAC control element (MAC-CE)) to signal the expected data rate change to the network entity 105-a. The device 405-a may update one or more relevance scores based on a response from the network entity 105-a. For example, if a data rate is expected to increase, and if the network entity 105-a indicates that it cannot accommodate the increased data rate, the application client (e.g., the device 405-a) may lower one or more relevance scores (e.g., to fit within a recommended or supported bitrate or data rate from the network entity 105-a).

In a six-user holographic call (e.g., as shown in the signaling diagram 400), each user may be looking at user A corresponding to device 405-a (e.g., a presenter within the holographic call). User A may have users D, E, and F within a field of view of user A. Accordingly, each device 405 may transmit video frames of a corresponding user (and one or more other indications as described herein) to the application server 410. In response to receiving relevance scores from each device 405, the application server 410 may transmit video frames corresponding to user A to users B, C, D, E, and F (in accordance with user A being within the field of view of users B, C, D, E, and F). The application server 410 may transmit video frames corresponding to users D, E, and F to user A. In accordance with such aspects, the application server 410 may provide each device 405 with relevant holographic call data. In such an example, a downlink data rate of each device 405 may be decreased (e.g., by up to 80%), thereby allowing for latency reduction, more power saving opportunities, and reduced network loading, while also improving or at least maintaining a user experience. Further, techniques described herein may support a reduced uplink data rate for devices that are determined to be irrelevant to all other users (e.g., device 405-b and device 405-c, for example), thereby increasing power and resource savings.

FIG. 5 shows an example of a virtual setting 500 that supports user-assisted selection of forwarded data in holographic communications. The virtual setting 500 may implement or be implemented by one or more aspects as described herein with reference to FIGS. 1-4. For example, the virtual setting 500 may illustrate a top-down view of one or more users 505 within a holographic call (e.g., a digital or virtual environment observable by the one or more users 505, such as via a headset or other holographic/3D rendering technology).

The virtual setting 500 may illustrate a virtual (e.g., digital) position of each user 505 within the holographic call. Similarly, the virtual setting 500 may illustrate a field of view 510 (e.g., a perspective within the virtual setting 500) corresponding to each user 505. A field of view 510 may represent a current or predicted field of view (e.g., predicted to be relevant to a user when the call data is to be downloaded). For example, a field of view 510-a may represent a perspective (e.g., view) of a user 505-a within the virtual setting 500. That is, the user 505-a may see objects or other users 505 within the virtual setting 500 that are within the field of view 510-a. Similarly, a field of view 510-b may correspond to a user 505-b and a field of view 510-c may correspond to a user 505-c. Although three users are illustrated in the virtual setting 500, the virtual setting 500 may support any quantity of users, such as four users, five users, six users, seven users, or eight users, among other examples. In some examples, each user 505 may represent an avatar (e.g., a virtual character or person) within the virtual environment, and each avatar may correspond to (or may be controlled by) a person in the physical world. Accordingly, a person (e.g., corresponding to a user 505) in the physical world may control a field of view 510 within the virtual setting 500 using a wireless device, such as a UE 115 and/or a peripheral device (e.g., using a VR or XR headset, a controller, a cell phone, or other communication device).

In a holographic call, a user 505 may look in a direction of one or more users 505 in the call (e.g., a subset of users within the call). In some cases, a rendering engine at a UE 115 corresponding to the user 505 may generate a frame (e.g., a video frame, a VR frame) that includes only the one or more users 505 in the field of view 510 corresponding to the user 505. Accordingly, downloaded data corresponding to other users 505 outside the field of view 510 (which may be referred to herein as “irrelevant users”) may be of no or of relatively little use for the user 505.

As described herein, one or more wireless communication devices (UEs 115) may utilize techniques to enable user-assisted selection of forwarded data in holographic communications. For example, a wireless device (e.g., a UE 115 corresponding to a user 505) associated with a first user 505-a may transmit, to an application server (e.g., an SFU), information that may allow the application server to determine a set of video frames to transmit to the wireless device. The set of video frames may include video frames depicting users 505 within a field of view 510-a of the first user 505-a within the virtual setting 500. The wireless device may transmit a first message as part of holographic communications between a set of users 505 including the first user 505-a and one or more other users 505. The first message may indicate one or more first relevance values associated with the one or more other users 505.

The wireless device (e.g., corresponding to the first user 505-a) may determine the one or more first relevance values based on the first field of view 510-a of the first user 505-a within the virtual setting associated with the holographic communications between the set of users 505. An example of the one or more first relevance values is depicted in Table 1. For example, the user 505-a may transmit the first message indicating a relevance value (e.g., relevance score) of 1 corresponding to user 505-b and a relevance value of 0 corresponding to user 505-c (e.g., since user 505-b is within the field of view 510-a and user 505-c is outside the field of view 510-a). Similarly, the user 505-b may transmit a second message indicating a relevance value of 1 corresponding to user 505-a and a relevance value of 0 corresponding to user 505-c. The user 505-c may transmit a third message indicating a relevance value of 0.5 corresponding to user 505-a and a relevance value of 1 corresponding to user 505-b (e.g., since user 505-a is partially within the field of view 510-c and user 505-b is inside the field of view 510-c).

TABLE 1
Relevance Values by User Point of View

| | Relevance | Relevance | Relevance |
|---|---|---|---|
| | Value | Value | Value |
| | of User | of User | of User |
| | 505-a | 505-b | 505-c |
| From the Point of | — | 1 | 0 |
| View of User 505-a | | | |
| From the Point of | 1 | — | 0 |
| View of User 505-b | | | |
| From the Point of | 0.5 | 1 | — |
| View of User 505-c | | | |

Although the relevance values in Table 1 include values between 0 and 1 (e.g., representing what portion of each user is within each field of view 510 within a range of 0 to 1), relevance values may be represented by other values without exceeding the scope of the present disclosure. For example, a relevance value may be indicted as a binary relevance value (e.g., 0 or 1) that indicates whether a user 505 is inside or outside a field of view 510. Additionally, or alternatively, a relevance value may be indicated as a ternary value (e.g., completely inside, completely outside, or partially inside the field of view 510). Additionally, or alternatively, a relevance value may be indicated as a percentage of each other user's avatar that is inside (or outside) the field of view 510 (e.g., for a more granular indication). Additionally, or alternatively, a relevance value (or additional information provided along with a relevance score) may indicate which portion(s) of a user 505 are within a field of view 510.

The application server may obtain the one or more first relevance values (and the other relevance values of the second message and the third message), and may further obtain video frames associated with each of the set of users 505 (e.g., from the user 505-a, the user 505-b, and the user 505-c). Accordingly, the application server may output one or more first video frames, of the video frames, associated with the first field of view 510-a of the first user 505-a in accordance with the one or more first relevance values. The one or more first video frames may indicate one or more visual characteristics of at least one user 505 of the one or more other users 505 within the virtual setting. The one or more visual characteristics may be in accordance with the one or more first relevance values. Thus, the wireless device may receive video frames for the first user 505-a that are relevant for the first field of view 510-a. The wireless device may further update the relevance values to the application server (e.g., after a change in the field of view 510-a, a change in a speaker, among other examples).

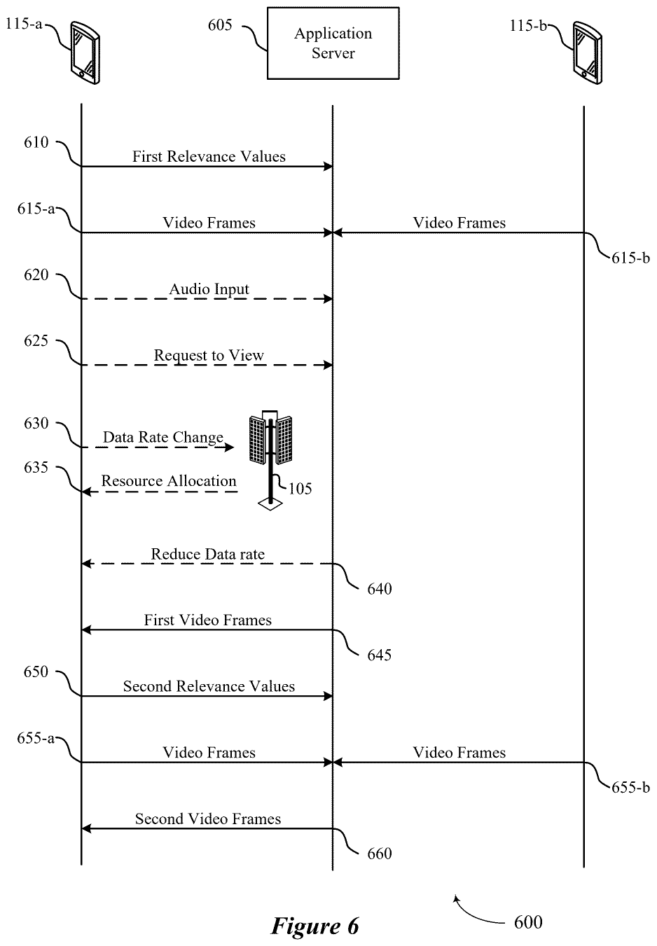

FIG. 6 shows an example of a process flow 600 that supports user-assisted selection of forwarded data in holographic communications. The process flow 600 includes a UE 115-a, an application server 605, and a UE 115-b, which may be examples of corresponding devices as described with respect to FIGS. 1-5. In the following description of the process flow 600, the operations between the UE 115-a, the application server 605, and the UE 115-b may be performed in a different order than the example order shown. Some operations may also be omitted from the process flow 600, and other operations may be added to the process flow 600. Further, although some operations or signaling may be shown to occur at different times for discussion purposes, these operations may occur at the same time. In some cases, operations performed by the UE 115-a may be performed by the UE 115-b.

At 610, the UE 115-a may transmit a first message as part of holographic communications between a set of users including a first user and one or more other users. The first message may indicate one or more first relevance values associated with the one or more other users. The one or more first relevance values may be based on a first field of view of the first user within a virtual setting associated with the holographic communications between the set of users. In some aspects, each relevance value of the one or more first relevance values may be associated with a respective user of the one or more other users. In some aspects, the one or more first relevance values may be further based on one or more modem inputs, eye tracking information, one or more settings configured at the wireless communication device, or any combination thereof. In some examples, the first field of view of the first user may be a predicted field of view of the first user within the virtual setting.

The application server 605 may obtain (e.g., receive) the first message including the one or more first relevance values. Similarly, the application server 605 may obtain, as part of the holographic communications between the set of users, one or more second relevance values associated with one or more third users of the set of users. The one or more second relevance values may be based on a second field of view of a second user of the set of users within the virtual setting associated with the holographic communications between the set of users.

At 615-a and at 615-b, the application server 605 may obtain, from the UE 115-a, the UE 115-b, or both, a first set of video frames associated with the holographic communications between the set of users (e.g., video frames depicting the users associated with the holographic communications). In some aspects, the UE 115-a may transmit a message that indicates one or more video frames associated with one or more visual characteristics of the first user within the virtual setting. The message may further indicate information associated with a movement or a rotation of the first user in a three-dimensional space associated with the virtual setting (e.g., six degrees of freedom corresponding to the first user, the UE 115-a, or both). In some aspects, the application server 605 may obtain (e.g., receive) a second set of video frames associated with the holographic communications between the set of users. Generally, the application server 605 may obtain any quantity of sets of video frames associated with the holographic communications between the set of users. For example, the application server 605 may obtain a respective set of one or more video frames from each user of the set of users associated with the holographic communications.

At 620, the UE 115-a may transmit an indication of an audio input by the first user as part of the holographic communications between the set of users. Additionally, or alternatively, the application server 605 may obtain an indication of an audio input by at least one user of the one or more other users. At 625, the UE 115-a may transmit a request message that indicates a request to view one or more visual characteristics of at least one user of the one or more other users. For example, the request message may provide an indication of which parts of a hologram of another user the UE 115-a requests to download.

At 630, the UE 115-a may transmit, to a RAN node (e.g., a network entity 105), an indication of an expected data rate change based on a change in the one or more first relevance values. The indication of the expected data rate change may be associated with video frame transmissions to the UE 115-a. At 635, the UE 115-a may receive, from the RAN node (e.g., the network entity 105), information indicative of a resource allocation based on the expected data rate change associated with the video frame transmissions to the UE 115-a. The UE 115-a may continue to communicate with the application server 605 via the network entity 105 based on the resource allocation. For example, messaging between the application server 605 and the UE 115-a may be routed through the network entity 105, with the application server 605 outputting video frames and/or other messaging to the network entity 105 for (over-the-air) transmission by the network entity 105 to the UE 115-a and with the UE 115-a transmitting video frames and/or other messaging to the network entity 105 for provision or relaying to the application server 605.

At 640, the application server 605 may output (e.g., transmit) a message that indicates that the UE 115-a is to reduce an uplink video data rate based on one or more relevance values associated with the first user (from other users) failing to satisfy a threshold relevance value. For example, if the first user is irrelevant to other users (e.g., if the first user is outside a field of view of any other user), the UE 115-a may receive such a message from the application server 605.

At 645, the application server 605 may output (e.g., to the UE 115-a) one or more first video frames, of the first set of video frames, associated with the first field of view of the first user in accordance with the one or more first relevance values. In some examples, the application server 605 may output the one or more first video frames based on the one or more first relevance values satisfying one or more threshold relevance values. In some aspects, the application server 605 may output one or more second video frames, of the second set of video frames, associated with the second field of view of the second user (e.g., corresponding to the UE 115-b) in accordance with the one or more second relevance values.

Accordingly, the UE 115-a may receive the one or more first video frames associated with the first field of view of the first user in accordance with the one or more first relevance values. The one or more first video frames may be based on an indication of an audio input. For example, the one or more first video frames may be further based on an audio input by at least one user of the one or more other (e.g., second) users. The one or more first video frames may indicate one or more visual characteristics of at least one user of the one or more other users within the virtual setting, with the one or more visual characteristics in accordance with the one or more first relevance values. In some examples, the one or more first video frames may be further based on the request message (e.g., received at 625). For example, the one or more first video frames may indicate requested visual characteristics.

In some aspects, the application server 605 may output a first subset of video frames associated with a second user, of the one or more second users, in accordance with a first data rate based on a first relevance value associated with the second user satisfying a threshold relevance value. Additionally, or alternatively, the application server 605 may output a second subset of video frames associated with a third user, of the one or more second users, in accordance with a second data rate, lower than the first data rate, based on a second relevance value associated with the third user failing to satisfy the threshold relevance value.

At 650, the UE 115-a may transmit a second message as part of the holographic communications between the set of users. The second message may indicate one or more second relevance values associated with the one or more other users. The one or more second relevance values may be based on a second field of view of the first user (e.g., a change in the first user's field of view) within the virtual setting associated with the holographic communications between the set of users.

At 655-a and at 655-b, the application server 605 may obtain, from the UE 115-a, the UE 115-b, or both, a second set of video frames associated with the holographic communications between the set of users (e.g., video frames depicting the users associated with the holographic communications). At 660, the UE 115-a may receive one or more second video frames (of the second set of video frames) associated with the second field of view of the first user in accordance with the one or more second relevance values.

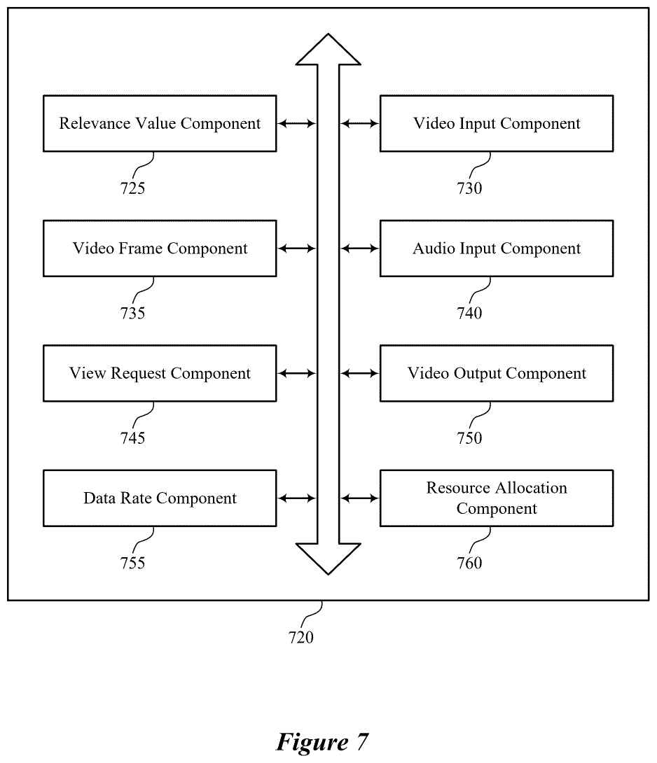

FIG. 7 shows an example of a processing system 720 that supports user-assisted selection of forwarded data in holographic communications. A processing system 720 may be an example of a processing system 140 (such as of a UE 115) and may include a relevance value component 725, a video input component 730, a video frame component 735, an audio input component 740, a view request component 745, a video output component 750, a data rate component 755, a resource allocation component 760, or any combination thereof. A processing system 720, or various component thereof, may be an example of means for performing (such as a means for causing a UE 115 to perform) various techniques described herein.

The relevance value component 725 may be configured to cause the UE 115 to transmit, as part of holographic communications between a set of users including a first user and one or more other users, a first message that indicates one or more first relevance values associated with the one or more other users, where the one or more first relevance values are based on a first field of view of the first user within a virtual setting associated with the holographic communications between the set of users. The video input component 730 may be configured to cause the UE 115 to receive one or more first video frames associated with the first field of view of the first user in accordance with the one or more first relevance values.

In some examples, the relevance value component 725 may be configured to cause the UE 115 to transmit, as part of the holographic communications between the set of users, a second message that indicates one or more second relevance values associated with the one or more other users, where the one or more second relevance values are based on a second field of view of the first user within the virtual setting associated with the holographic communications between the set of users. In some examples, the video frame component 735 may be configured to cause the UE 115 to receive one or more second video frames associated with the second field of view of the first user in accordance with the one or more second relevance values.

In some examples, the one or more first video frames are further based on an audio input by at least one user of the one or more other users.

In some examples, the audio input component 740 may be configured to cause the UE 115 to transmit an indication of an audio input by the first user as part of the holographic communications between the set of users.

In some examples, the view request component 745 may be configured to cause the UE 115 to transmit a request message that indicates a request to view one or more visual characteristics of at least one user of the one or more other users, where the one or more first video frames are further based on the request.

In some examples, the video output component 750 may be configured to cause the UE 115 to transmit a message that indicates one or more video frames associated with one or more visual characteristics of the first user within the virtual setting, the message further indicating information associated with a movement or a rotation of the first user in a three-dimensional space associated with the virtual setting.

In some examples, the data rate component 755 may be configured to cause the UE 115 to transmit, based on a change in the one or more first relevance values, an indication of an expected data rate change associated with video frame transmissions to the wireless communication device. In some examples, the resource allocation component 760 may be configured to cause the UE 115 to receive information indicative of a resource allocation based on the expected data rate change associated with the video frame transmissions to the wireless communication device.

In some examples, the one or more first video frames indicate one or more visual characteristics of at least one user of the one or more other users within the virtual setting. In some examples, the one or more visual characteristics are in accordance with the one or more first relevance values.

In some examples, each relevance value of the one or more first relevance values is associated with a respective user of the one or more other users.

In some examples, the first field of view of the first user includes a predicted field of view of the first user within the virtual setting.

In some examples, the one or more first relevance values are further based on one or more modem inputs, eye tracking information, one or more settings configured at the wireless communication device, or any combination thereof.

A processing system 720 may include or be a component of one or more chips, systems-on-chips (SoCs), chipsets, packages, components, or devices that individually or collectively constitute or include a processing system. A processing system 720 may interface with other components of a processing system 720. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a processing system 720).

By including or configuring a processing system 720 for operation in a processing system 720 as described herein, the processing system 720 may support techniques for user-assisted selection of forwarded data in holographic communications, which may result in reduced processing, reduced power consumption, reduced latency, power saving, reduced network loading due to reduced data rates, and more efficient utilization of communication resources.

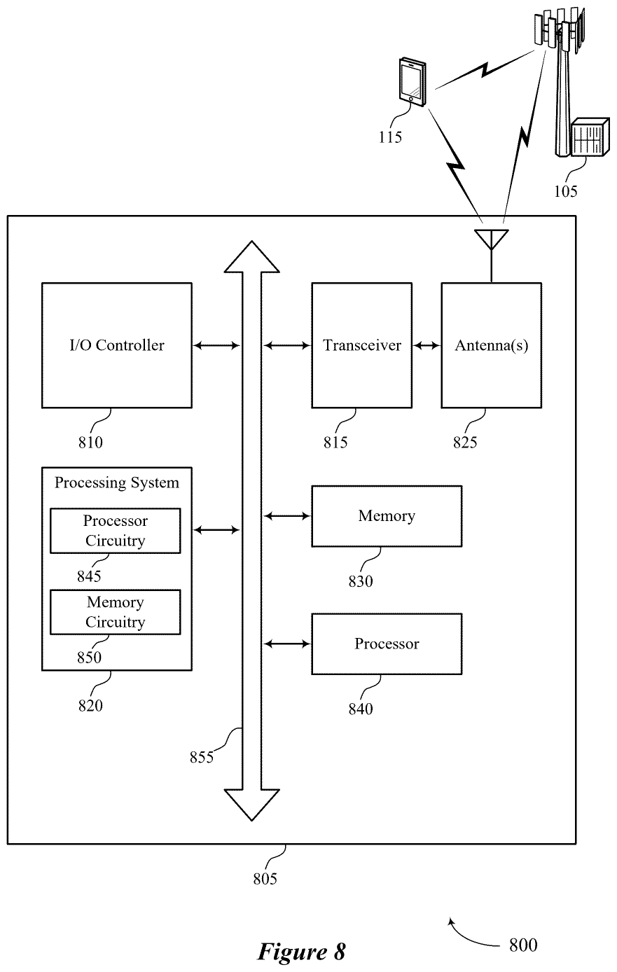

FIG. 8 shows an example of a system 800 including a device 805 that supports user-assisted selection of forwarded data in holographic communications. The device 805 may be an example of or include components of UE 115 (e.g., a wireless communication device). The device 805 may communicate (such as wirelessly) with one or more other devices (such as network entities 105, UEs 115). The device 805 may include components for transmitting and receiving communication, which may include a processing system 820, an input/output (I/O) controller, such as an I/O controller 810, a transceiver 815, antenna(s) 825, a memory 830, and a processor 840. Components of the device 805 may be coupled (such as operatively, communicatively, functionally, electronically, electrically, in electronic communication) a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840, cause the device 805 to perform various functions (such as to support an application of the device 805). The I/O controller 810 may manage inputs and outputs for the device 805, may manage peripherals not integrated into the device 805, or may represent a physical connection (such as port) to an external peripheral. The processor 840 may interact with a modem, a keyboard, a mouse, a touchscreen, or other device (such as via I/O controller 810). In some aspects, a user may interact with the device 805 via the I/O controller 810 or via hardware components controlled by the I/O controller 810.

The processing system 820 may be an example of a processing system 140 or a processing system 720. For example, the processing system 820 may include processor circuitry 845 and memory circuitry 850 that stores code, and may be configured to cause the device 805 to perform operations that support user-assisted selection of forwarded data in holographic communications. Although the processing system 820 is illustrated as a separate component, which may involve a separate chip, chipset, or other module, in some aspects, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

By including or configuring the processing system 820 for operation in the device 805 as described herein, may support techniques for user-assisted selection of forwarded data in holographic communications, which may result in reduced processing, reduced power consumption, improved communication reliability, reduced latency, power saving, reduced network loading due to reduced data rates, improved coordination between devices, longer battery life, improved utilization of processing capability, and more efficient utilization of communication resources.

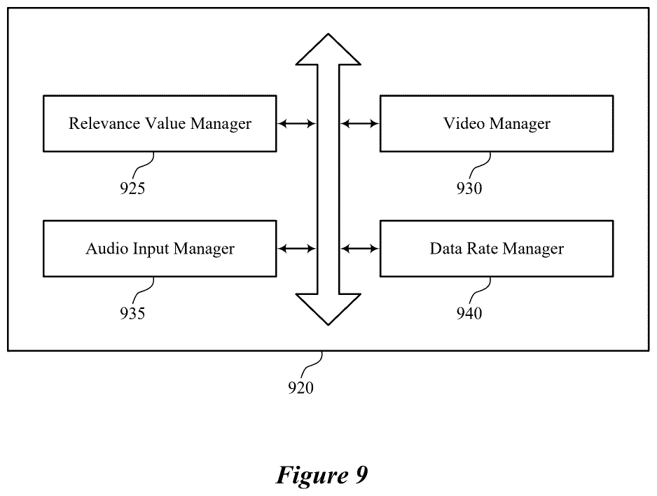

FIG. 9 shows an example of a processing system 920 that supports user-assisted selection of forwarded data in holographic communications. A processing system 920 may be an example of a processing system 145 (such as a network entity 105 or an application server) and may include a relevance value manager 925, a video manager 930, an audio input manager 935, a data rate manager 940, or any combination thereof. A processing system 920, or various component thereof, may be an example of means for performing (such as a means for causing a network entity 105 to perform) various techniques described herein.

The relevance value manager 925 may be configured to cause the network entity 105 to obtain, as part of holographic communications between a set of users including a first user and one or more second users, one or more first relevance values associated with the one or more second users, where the one or more first relevance values are based on a first field of view of the first user within a virtual setting associated with the holographic communications between the set of users. The video manager 930 may be configured to cause the network entity 105 to obtain a first set of video frames associated with the holographic communications between the set of users. In some examples, the video manager 930 may be configured to cause the network entity 105 to output one or more first video frames, of the first set of video frames, associated with the first field of view of the first user in accordance with the one or more first relevance values.

In some examples, the relevance value manager 925 may be configured to cause the network entity 105 to obtain, as part of the holographic communications between the set of users, one or more second relevance values associated with one or more third users of the set of users, where the one or more second relevance values are based on a second field of view of a second user of the set of users within the virtual setting associated with the holographic communications between the set of users. In some examples, the video manager 930 may be configured to cause the network entity 105 to obtain a second set of video frames associated with the holographic communications between the set of users. In some examples, the video manager 930 may be configured to cause the network entity 105 to output one or more second video frames, of the second set of video frames, associated with the second field of view of the second user in accordance with the one or more second relevance values.

In some examples, the audio input manager 935 may be configured to cause the network entity 105 to obtain an indication of an audio input by at least one user of the one or more second users, where the one or more first video frames are based on the indication of the audio input.

In some examples, to support outputting the one or more first video frames, the video manager 930 may be configured to cause the network entity 105 to output the one or more first video frames based on the one or more first relevance values satisfying one or more threshold relevance values.

In some examples, to support outputting the one or more first video frames, the video manager 930 may be configured to cause the network entity 105 to output a first subset of video frames associated with a second user, of the one or more second users, in accordance with a first data rate based on a first relevance value associated with the second user satisfying a threshold relevance value. In some examples, to support outputting the one or more first video frames, the video manager 930 may be configured to cause the network entity 105 to output a second subset of video frames associated with a third user, of the one or more second users, in accordance with a second data rate, lower than the first data rate, based on a second relevance value associated with the third user failing to satisfy the threshold relevance value.

In some examples, the data rate manager 940 may be configured to cause the network entity 105 to output a message that indicates that the first user is to reduce an uplink video data rate based on one or more relevance values associated with the first user failing to satisfy a threshold relevance value.

In some examples, to support outputting the one or more first video frames, the video manager 930 may be configured to cause the network entity 105 to output the one or more first video frames to a wireless communication device associated with the first user.

In some examples, the one or more first video frames indicate one or more visual characteristics of at least one user of the one or more second users within the virtual setting. In some examples, the one or more visual characteristics are in accordance with the one or more first relevance values.

In some examples, each relevance value of the one or more first relevance values is associated with a respective user of the one or more second users.

A processing system 920 may include or be an example of one or more chips, SoCs, chipsets, packages, components, or devices that individually or collectively constitute or include a processing system. A processing system 920 may interface with other components of a network entity 105. For example, operations described with reference to a processing system 920, or various components thereof, may be performed by or with other such components, including a receiver, a transmitter, a transceiver, a modem, a user interface, a modulator/demodulator, an encoder/decoder, or any combination thereof (such as of the processing system 920, coupled with the processing system 920, of a network entity 105). Operations described herein with reference to the processing system 920, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 920 for operation in a processing system 920 as described herein, the processing system 920 may support techniques for user-assisted selection of forwarded data in holographic communications, which may result in reduced processing, reduced power consumption, reduced latency, power saving, reduced network loading due to reduced data rates, and more efficient utilization of communication resources.

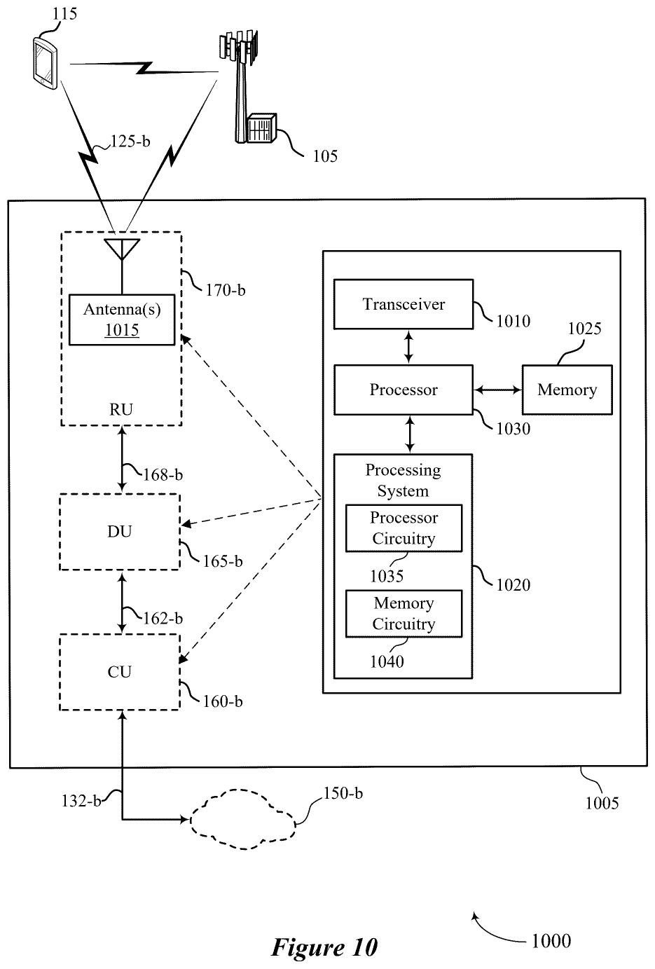

FIG. 10 shows an example of a system 1000 including a device 1005 that supports user-assisted selection of forwarded data in holographic communications. The device 1005 may communicate (such as via one or more wired interfaces or one or more wireless interfaces) with other network devices or network equipment such as a core network 150-b, other network entities 105, UEs 115, or any combination thereof. The device 1005 may include components for transmitting and receiving communication, which may include a processing system 1020, a transceiver 1010, antenna(s) 1015, a memory 1025, and a processor 1030. Components of the device 1005 may be coupled (such as operatively, communicatively, functionally, electronically, electrically, in electronic communication) via one or more interfaces.

The transceiver 1010 may communicate bi-directionally with another transceiver via wired or wireless links, and may support transmission operations, reception operations, or both, as described herein. The transceiver 1010 may include a modem to modulate and demodulate signals, to provide the modulated signals for transmission (such as via antenna(s) 1015, via a wired interface), and to demodulate received signals (such as received via antenna(s) 1015, received via a wired interface). The transceiver 1010 may be operable to support communication via one or more communication links (such as a communication link 125-b, a backhaul link 132-b, a midhaul link 162-b, fronthaul link 168-b).

The processor 1030 may be a general-purpose processing component that supports various operations (such as applications) of the device 1005. The memory 1025 may be a general-purpose storage component that stores code executable by the processor 1030. Such code may include instructions that, when executed by the processor 1030, cause the device 1005 to perform various functions (such as to support an application of the device 1005).

For examples in which the device 1005 is a network entity 105 in a disaggregated architecture, one or more components of the device 1005 may be located at one or more of a CU 160-b, a DU 165-b, or an RU 170-b, one or more of which may include aspects of the processing system 1020, the processor 1030, the memory 1025, or the transceiver 1010. Functions of the device 1005 may be performed at different components or an operation may be divided between different components (such as different functions being supported by aspects of the CU 160-b, the DU 165-b, or the RU 170-b, the transceiver 1010, the processor 1030, the memory 1025, the processing system 1020, or any combination thereof). For example, the processing system 1020 may be a component of one or more of the CU 160-b, the DU 165-b, or the RU 170-b. In some examples, interfaces between components of device 1005 (such as CU 160-b, DU 165-b, RU 170-b) may support communication at a protocol layer or between protocol layers of a protocol stack.

In some examples, the processing system 1020 may manage aspects of communication with the core network 150-b (such as via a backhaul link 132). For example, the processing system 1020 may manage the transfer of data communication for UEs 115 with a gateway of the core network 150-b. In some examples, the processing system 1020 may manage communication with one or more other network entities 105 and may include a controller or scheduler for controlling communication with UEs 115 (such as in cooperation with the one or more other network entities 105). In some examples, the processing system 1020 may support an interface (such as X2 interface, Xn interface) to provide communication between network entities 105.

The processing system 1020 may be an example of a processing system 145 or a processing system 920. For example, the processing system 1020 may include processor circuitry 1035 and memory circuitry 1040 that stores code, and the processing system 1020 may be configured to cause the device 1005 to perform operations that support user-assisted selection of forwarded data in holographic communications. Although the processing system 1020 is illustrated as a separate component, which may involve a separate chip, chipset, or other module, in some aspects, one or more functions described with reference to the processing system 1020 may be supported by or performed by a transceiver 1010, antenna(s) 1015, a processor 1030, memory 1025, or any combination thereof, such that a processing system 1020 may include one or more of a transceiver 1010, antenna(s) 1015, a processor 1030, memory 1025, or any combination thereof. Further, processor circuitry 1035 and memory circuitry 1040 each may be implemented at the device 1005 in accordance with an aggregated architecture, or the processor circuitry 1035 and the memory circuitry 1040 may be implemented at one or more of a CU 160-b, a DU 165-b, or an RU 170-b in accordance with a disaggregated architecture.

By including or configuring the processing system 1020 for operation in the device 1005 as described herein, may support techniques for user-assisted selection of forwarded data in holographic communications, which may result in reduced processing, reduced power consumption, improved communication reliability, reduced latency, power saving, reduced network loading due to reduced data rates, improved coordination between devices, longer battery life, improved utilization of processing capability, and more efficient utilization of communication resources.

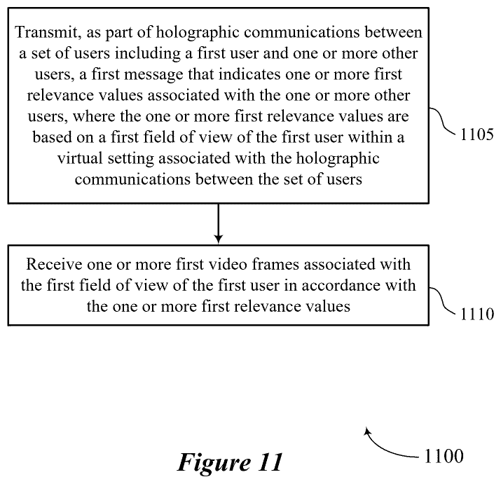

FIG. 11 shows an example of a method 1100 that supports user-assisted selection of forwarded data in holographic communications. Operations of the method 1100 may be performed by a UE (e.g., a wireless communication device) or its components (such as using a processing system configured to cause the UE 115 to perform one or more of the operations) as described herein.

At 1105, the method may include transmitting, as part of holographic communications between a set of users including a first user and one or more other users, a first message that indicates one or more first relevance values associated with the one or more other users, where the one or more first relevance values are based on a first field of view of the first user within a virtual setting associated with the holographic communications between the set of users. The operations of 1105 may be performed in accordance with examples as disclosed herein, such as in accordance with transmission of the first relevance values at 610 of FIG. 6. The one or more first relevance values may be an example of values as described with reference to FIG. 5 (such as in Table 1). In some examples, aspects of the operations of 1105 may be performed by a relevance value component 725. Additionally, or alternatively, aspects of the operations of 1105 may be performed by the device 805 in association with the processing system 820 executing the code stored in the memory 830, as described with reference to FIG. 8.

At 1110, the method may include receiving one or more first video frames associated with the first field of view of the first user in accordance with the one or more first relevance values. The operations of 1110 may be performed in accordance with examples as disclosed herein, such as in accordance with reception of the first video frames at 645 of FIG. 6. In some examples, aspects of the operations of 1110 may be performed by a video input component 730. Additionally, or alternatively, aspects of the operations of 1110 may be performed by the device 805 in association with the processing system 820 executing the code stored in the memory 830, as described with reference to FIG. 8.

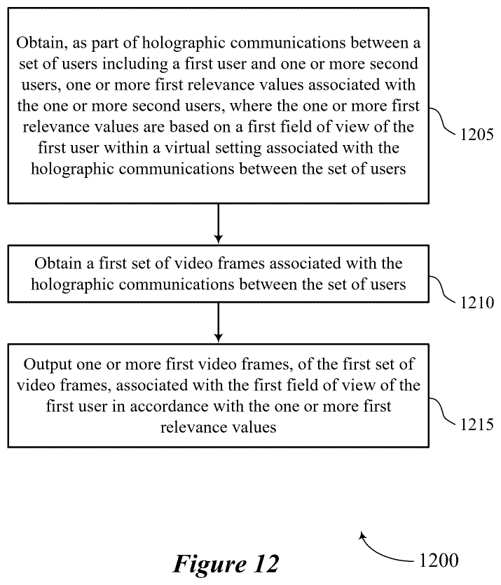

FIG. 12 shows an example of a method 1200 that supports user-assisted selection of forwarded data in holographic communications. Operations of the method 1200 may be performed by a network entity 105 (e.g., an application server) or its components (such as using a processing system configured to cause the network entity to perform one or more operations) as described herein.

At 1205, the method may include obtaining, as part of holographic communications between a set of users including a first user and one or more second users, one or more first relevance values associated with the one or more second users, where the one or more first relevance values are based on a first field of view of the first user within a virtual setting associated with the holographic communications between the set of users. The operations of 1205 may be performed in accordance with examples as disclosed herein, such as in accordance with transmission of the first relevance values at 610 of FIG. 6. The one or more first relevance values may be an example of values as described with reference to FIG. 5 (such as in Table 1). In some examples, aspects of the operations of 1205 may be performed by a relevance value manager 925. Additionally, or alternatively, aspects of the operations of 1205 may be performed by the device 1005 in association with the processing system 1020 executing the code stored in the memory 1025, as described with reference to FIG. 10.

At 1210, the method may include obtaining a first set of video frames associated with the holographic communications between the set of users. The operations of 1210 may be performed in accordance with examples as disclosed herein, such as in accordance with transmission of the video frames at 615-a and 615-b of FIG. 6. In some examples, aspects of the operations of 1210 may be performed by a video manager 930. Additionally, or alternatively, aspects of the operations of 1210 may be performed by the device 1005 in association with the processing system 1020 executing the code stored in the memory 1025, as described with reference to FIG. 10.

At 1215, the method may include outputting one or more first video frames, of the first set of video frames, associated with the first field of view of the first user in accordance with the one or more first relevance values. The operations of 1215 may be performed in accordance with examples as disclosed herein, such as in accordance with transmission of the first video frames at 645 of FIG. 6. In some examples, aspects of the operations of 1215 may be performed by a video manager 930. Additionally, or alternatively, aspects of the operations of 1215 may be performed by the device 1005 in association with the processing system 1020 executing the code stored in the memory 1025, as described with reference to FIG. 10.
Aspect 1: A method for wireless communications at a wireless communication device, comprising: transmitting, as part of holographic communications between a set of users comprising a first user and one or more other users, a first message that indicates one or more first relevance values associated with the one or more other users, wherein the one or more first relevance values are based at least in part on a first field of view of the first user within a virtual setting associated with the holographic communications between the set of users; and receiving one or more first video frames associated with the first field of view of the first user in accordance with the one or more first relevance values.
Aspect 2: The method of aspect 1, further comprising: transmitting, as part of the holographic communications between the set of users, a second message that indicates one or more second relevance values associated with the one or more other users, wherein the one or more second relevance values are based at least in part on a second field of view of the first user within the virtual setting associated with the holographic communications between the set of users; and receiving one or more second video frames associated with the second field of view of the first user in accordance with the one or more second relevance values.
Aspect 3: The method of any of aspects 1 through 2, wherein the one or more first video frames are further based at least in part on an audio input by at least one user of the one or more other users.
Aspect 4: The method of any of aspects 1 through 3, further comprising: transmitting an indication of an audio input by the first user as part of the holographic communications between the set of users.
Aspect 5: The method of any of aspects 1 through 4, further comprising: transmitting a request message that indicates a request to view one or more visual characteristics of at least one user of the one or more other users, wherein the one or more first video frames are further based at least in part on the request.
Aspect 6: The method of any of aspects 1 through 5, further comprising: transmitting a message that indicates one or more video frames associated with one or more visual characteristics of the first user within the virtual setting, the message further indicating information associated with a movement or a rotation of the first user in a three-dimensional space associated with the virtual setting.
Aspect 7: The method of any of aspects 1 through 6, further comprising: transmitting, based at least in part on a change in the one or more first relevance values, an indication of an expected data rate change associated with video frame transmissions to the wireless communication device; and receiving information indicative of a resource allocation based at least in part on the expected data rate change associated with the video frame transmissions to the wireless communication device.
Aspect 8: The method of any of aspects 1 through 7, wherein the one or more first video frames indicate one or more visual characteristics of at least one user of the one or more other users within the virtual setting, and the one or more visual characteristics are in accordance with the one or more first relevance values.
Aspect 9: The method of any of aspects 1 through 8, wherein each relevance value of the one or more first relevance values is associated with a respective user of the one or more other users.
Aspect 10: The method of any of aspects 1 through 9, wherein the first field of view of the first user comprises a predicted field of view of the first user within the virtual setting.
Aspect 11: The method of any of aspects 1 through 10, wherein the one or more first relevance values are further based at least in part on one or more modem inputs, eye tracking information, one or more settings configured at the wireless communication device, or any combination thereof.
Aspect 12: A method for wireless communications at an application server, comprising: obtaining, as part of holographic communications between a set of users comprising a first user and one or more second users, one or more first relevance values associated with the one or more second users, wherein the one or more first relevance values are based at least in part on a first field of view of the first user within a virtual setting associated with the holographic communications between the set of users; obtaining a first set of video frames associated with the holographic communications between the set of users; and outputting one or more first video frames, of the first set of video frames, associated with the first field of view of the first user in accordance with the one or more first relevance values.
Aspect 13: The method of aspect 12, further comprising: obtaining, as part of the holographic communications between the set of users, one or more second relevance values associated with one or more third users of the set of users, wherein the one or more second relevance values are based at least in part on a second field of view of a second user of the set of users within the virtual setting associated with the holographic communications between the set of users; obtaining a second set of video frames associated with the holographic communications between the set of users; and outputting one or more second video frames, of the second set of video frames, associated with the second field of view of the second user in accordance with the one or more second relevance values.
Aspect 14: The method of any of aspects 12 through 13, further comprising: obtaining an indication of an audio input by at least one user of the one or more second users, wherein the one or more first video frames are based at least in part on the indication of the audio input.
Aspect 15: The method of any of aspects 12 through 14, wherein outputting the one or more first video frames comprises: outputting the one or more first video frames based at least in part on the one or more first relevance values satisfying one or more threshold relevance values.
Aspect 16: The method of any of aspects 12 through 15, wherein outputting the one or more first video frames comprises: outputting a first subset of video frames associated with a second user, of the one or more second users, in accordance with a first data rate based at least in part on a first relevance value associated with the second user satisfying a threshold relevance value; and outputting a second subset of video frames associated with a third user, of the one or more second users, in accordance with a second data rate, lower than the first data rate, based at least in part on a second relevance value associated with the third user failing to satisfy the threshold relevance value.
Aspect 17: The method of any of aspects 12 through 16, further comprising: outputting a message that indicates that the first user is to reduce an uplink video data rate based at least in part on one or more relevance values associated with the first user failing to satisfy a threshold relevance value.
Aspect 18: The method of any of aspects 12 through 17, wherein outputting the one or more first video frames comprises: outputting the one or more first video frames to a wireless communication device associated with the first user.
Aspect 19: The method of any of aspects 12 through 18, wherein the one or more first video frames indicate one or more visual characteristics of at least one user of the one or more second users within the virtual setting, and the one or more visual characteristics are in accordance with the one or more first relevance values.
Aspect 20: The method of any of aspects 12 through 19, wherein each relevance value of the one or more first relevance values is associated with a respective user of the one or more second users.
Aspect 21: A wireless communication device for wireless communications, comprising a processing system that includes processor circuitry and memory circuitry that stores code, the processing system configured to cause the wireless communication device to perform a method of any of aspects 1 through 11.
Aspect 22: A wireless communication device for wireless communications, comprising at least one means for performing a method of any of aspects 1 through 11.
Aspect 23: A non-transitory computer-readable medium storing code for wireless communications, the code comprising instructions executable by one or more processors to perform a method of any of aspects 1 through 11.
Aspect 24: An application server for wireless communications, comprising a processing system that includes processor circuitry and memory circuitry that stores code, the processing system configured to cause the application server to perform a method of any of aspects 12 through 20.
Aspect 25: An application server for wireless communications, comprising at least one means for performing a method of any of aspects 12 through 20.
Aspect 26: A non-transitory computer-readable medium storing code for wireless communications, the code comprising instructions executable by one or more processors to perform a method of any of aspects 12 through 20.

It should be noted that methods described herein describe possible implementations (e.g., aspects). Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A wireless communication device, comprising:
a processing system that includes processor circuitry and memory circuitry that stores code, the processing system configured to cause the wireless communication device to:
transmit, as part of holographic communications between a set of users comprising a first user and one or more other users, a first message that indicates one or more first relevance values associated with the one or more other users, wherein the one or more first relevance values are based at least in part on a first field of view of the first user within a virtual setting associated with the holographic communications between the set of users; and
receive one or more first video frames associated with the first field of view of the first user in accordance with the one or more first relevance values.

2. The wireless communication device of claim 1, wherein the processing system is further configured to cause the wireless communication device to:
transmit, as part of the holographic communications between the set of users, a second message that indicates one or more second relevance values associated with the one or more other users, wherein the one or more second relevance values are based at least in part on a second field of view of the first user within the virtual setting associated with the holographic communications between the set of users; and
receive one or more second video frames associated with the second field of view of the first user in accordance with the one or more second relevance values.

3. The wireless communication device of claim 1, wherein the one or more first video frames are further based at least in part on an audio input by at least one user of the one or more other users.

4. The wireless communication device of claim 1, wherein the processing system is further configured to cause the wireless communication device to:
transmit an indication of an audio input by the first user as part of the holographic communications between the set of users.

5. The wireless communication device of claim 1, wherein the processing system is further configured to cause the wireless communication device to:
transmit a request message that indicates a request to view one or more visual characteristics of at least one user of the one or more other users, wherein the one or more first video frames are further based at least in part on the request.

6. The wireless communication device of claim 1, wherein the processing system is further configured to cause the wireless communication device to:
transmit a message that indicates one or more video frames associated with one or more visual characteristics of the first user within the virtual setting, the message further indicating information associated with a movement or a rotation of the first user in a three-dimensional space associated with the virtual setting.

7. The wireless communication device of claim 1, wherein the processing system is further configured to cause the wireless communication device to:
transmit, based at least in part on a change in the one or more first relevance values, an indication of an expected data rate change associated with video frame transmissions to the wireless communication device; and
receive information indicative of a resource allocation based at least in part on the expected data rate change associated with the video frame transmissions to the wireless communication device.

8. The wireless communication device of claim 1, wherein:
the one or more first video frames indicate one or more visual characteristics of at least one user of the one or more other users within the virtual setting, and
the one or more visual characteristics are in accordance with the one or more first relevance values.

9. The wireless communication device of claim 1, wherein each relevance value of the one or more first relevance values is associated with a respective user of the one or more other users.

10. The wireless communication device of claim 1, wherein the first field of view of the first user comprises a predicted field of view of the first user within the virtual setting.

11. The wireless communication device of claim 1, wherein the one or more first relevance values are further based at least in part on one or more modem inputs, eye tracking information, one or more settings configured at the wireless communication device, or any combination thereof.

12. An application server, comprising:
a processing system that includes processor circuitry and memory circuitry that stores code, the processing system configured to cause the application server to:
obtain, as part of holographic communications between a set of users comprising a first user and one or more second users, one or more first relevance values associated with the one or more second users, wherein the one or more first relevance values are based at least in part on a first field of view of the first user within a virtual setting associated with the holographic communications between the set of users;
obtain a first set of video frames associated with the holographic communications between the set of users; and
output one or more first video frames, of the first set of video frames, associated with the first field of view of the first user in accordance with the one or more first relevance values.

13. The application server of claim 12, wherein the processing system is further configured to cause the application server to:
obtain, as part of the holographic communications between the set of users, one or more second relevance values associated with one or more third users of the set of users, wherein the one or more second relevance values are based at least in part on a second field of view of a second user of the set of users within the virtual setting associated with the holographic communications between the set of users;
obtain a second set of video frames associated with the holographic communications between the set of users; and
output one or more second video frames, of the second set of video frames, associated with the second field of view of the second user in accordance with the one or more second relevance values.

14. The application server of claim 12, wherein the processing system is further configured to cause the application server to:
obtain an indication of an audio input by at least one user of the one or more second users, wherein the one or more first video frames are based at least in part on the indication of the audio input.

15. The application server of claim 12, wherein, to output the one or more first video frames, the processing system is configured to cause the application server to:
output the one or more first video frames based at least in part on the one or more first relevance values satisfying one or more threshold relevance values.

16. The application server of claim 12, wherein, to output the one or more first video frames, the processing system is configured to cause the application server to:
output a first subset of video frames associated with a second user, of the one or more second users, in accordance with a first data rate based at least in part on a first relevance value associated with the second user satisfying a threshold relevance value; and
output a second subset of video frames associated with a third user, of the one or more second users, in accordance with a second data rate, lower than the first data rate, based at least in part on a second relevance value associated with the third user failing to satisfy the threshold relevance value.

17. The application server of claim 12, wherein the processing system is further configured to cause the application server to:
output a message that indicates that the first user is to reduce an uplink video data rate based at least in part on one or more relevance values associated with the first user failing to satisfy a threshold relevance value.

18. The application server of claim 12, wherein, to output the one or more first video frames, the processing system is configured to cause the application server to:
output the one or more first video frames to a wireless communication device associated with the first user.

19. The application server of claim 12, wherein:
the one or more first video frames indicate one or more visual characteristics of at least one user of the one or more second users within the virtual setting, and
the one or more visual characteristics are in accordance with the one or more first relevance values.

20. A method for wireless communications at a wireless communication device, comprising:
transmitting, as part of holographic communications between a set of users comprising a first user and one or more other users, a first message that indicates one or more first relevance values associated with the one or more other users, wherein the one or more first relevance values are based at least in part on a first field of view of the first user within a virtual setting associated with the holographic communications between the set of users; and
receiving one or more first video frames associated with the first field of view of the first user in accordance with the one or more first relevance values.
